(19) United States
(12) Patent Application Publication
(10) Pub. No.: US 2019/0016056 A1
(43) Pub. Date: Jan. 17, 2019

(54) SHAPING DEVICE, SHAPING METHOD

(71) Applicant: MIMAKI ENGINEERING CO., LTD., Nagano (JP)

(72) Inventors: Shota Tsukahara, Nagano (JP); Tetsuya Katou, Nagano (JP); Yukihiro Uchiyama, Nagano (JP); Kyohei Maruyama, Nagano (JP)

(73) Assignee: MIMAKI ENGINEERING CO., LTD., Nagano (JP)

(21) Appl. No.: 16/027,359

(22) Filed: Jul. 4, 2018

(30) Foreign Application Priority Data
Jul. 14, 2017 (JP) 2017-137795

(51) Int. Cl. B29C 64/393; B33Y 10/00; B33Y 30/00; B33Y 50/02; B29C 64/112; B29C 64/307

(52) U.S. Cl. CPC B29C 64/393; B33Y 10/00; B33Y 30/00; B33Y 70/00; B29C 64/112; B29C 64/307; B33Y 50/02

(57) ABSTRACT

An ink supplying system includes a weight measuring portion that measures at least a weight of the ink, and an ink refilling pump that extracts the ink from a refill container capable of refilling the ink to an ink container and refills the ink to the ink container; the controller controls the ink refilling pump to refill the ink from the refill container to the ink container when the weight of the ink measured by the weight measuring portion becomes smaller than or equal to a predetermined set value; and the set value is changeable.

### CROSS REFERENCE TO RELATED APPLICATIONS

This application claims the priority benefit of Japanese Patent Application No. 2017-137795, filed on Jul. 14, 2017. The entirety of the above-mentioned patent application is hereby incorporated by reference herein and made a part of this specification.

### TECHNICAL FIELD

The present disclosure relates to a shaping device and a shaping method that carry out layering and shaping using an inkjet method.

### DESCRIPTION OF THE BACKGROUND ART

In recent years, a shaping device so-called 3D printer that molds a stereoscopic three-dimensional object is starting to be widespread used. The 3D printer outputs material as a thin layer, and layers a plurality of such layers to shape a three-dimensional shape. Such a 3D printer is expected to be used in many fields as trial production can be carried out without a die. A photolithography method, a thermal dissolution resin layering method, an inkjet method, a powder sintering method, and the like are known for the shaping method. Among such methods, the inkjet method ejects, for example, an acrylic light curable resin having a relatively low viscosity from a nozzle and layers such resin, and thus has an advantage over other methods of being able to output a high definition shape, and can give change to strength, and the like through component adjustment of the ink.

FIG. 10A is a schematic view of a shaping device 1 by an inkjet method. (see e.g., Japanese Unexamined Patent Publication No. 2016-16553). The shaping device 1 includes an inkjet head 10 that ejects ink, a scanning driver 20 that drives the inkjet head 10 in a three-dimensional direction, and a controller 30 that carries out a control of a movement of the scanning driver 20 and a control of discharging, and the like of the ink. The inkjet head 10 ejects ink in an XY plane direction with a movement in a Z direction fixed to carry out shaping to a layer form on a shaping table 40. In this case, when using an ultraviolet curable resin, for example, as ink, the ink is irradiated with an ultraviolet ray immediately after the shaping to be cured. The ink is layered in the Z direction to carry out a three-dimensional shaping. In the example of FIG. 10A, a support layer 42 is created using a material called a support material that can be removed after the shaping to carry out shaping of an overhang shape, that is, a shape in which a layer on a vertically upper side is wider than a layer on a vertically lower side with respect to two layers to be layered.

FIG. 10B is a cross-sectional view of a three-dimensional object 44. A front surface of the three-dimensional object 44 is formed with a colored layer 46, and a structural body that determines the shape is shaped on an inner side. The colored layer 46 is shaped with a coloring ink of a thickness of, for example, about 100 microns to 300 microns. The support layer 42 is formed on the lower side of an overhanging portion. When coloring the front surface of the three-dimensional object 44 in full color, a layer of white ink that reflects light is desirably provided on an immediate inner side of a coloring side layer, the thickness of such layer may be merely about 200 microns. In FIG. 10B, the white ink is used as an ink for shaping the structural body. Since a volume of the structural body is generally significantly larger than a volume of the colored layer, the consumption amount of the ink greatly differs between the coloring ink and the ink for shaping the interior of the structural body.

### SUMMARY

An inkjet type shaping device can produce a full color three-dimensional object with a high degree of accuracy. However, if the three-dimensional object becomes large, the shaping time becomes extremely long, and thus the shaping may take a few days continuously day and night and there is a risk the ink may run out. The operation thus may become cumbersome such as, for example, there may be a need to replace an ink container storing ink purposely using manpower on the weekend. Even if a large ink container is prepared to enable a continuous operation, if the ink is stored in the ink container for a long period of time, the ink becomes exposed to air, and deterioration such as oxidization, decomposition, penetration of dust, and aggregation of pigment particles may occur. Furthermore, the consumption amount greatly differs depending on the type of ink, as described above.

In light of the foregoing, the present disclosure provides a shaping device capable of refilling ink to an ink container under appropriate conditions.

One idea is to change the size of the ink container according to the type of ink, but this will lead to increase in cost. Thus, in the present disclosure, the ink container having the same capacity is used for each type of ink, and only the reference of adding and refilling the ink container can be flexibly changed and set according to the type of ink. Furthermore, in the present disclosure, the weight measuring portion for measuring at least the weight of the ink is provided for each ink to set the reference of adding and refilling the ink at high degree of accuracy and to flexibly change the reference.

(1) The present disclosure provides a shaping device that shapes a stereoscopic three-dimensional object by discharging ink, the shaping device including a plurality of inkjet heads that eject the ink of a color different from each other; a plurality of ink supplying systems that supply a corresponding ink to each of the plurality of inkjet heads; and a controller that controls a supply of the ink from the plurality of ink supplying systems to the plurality of inkjet heads; where each of the ink supplying system includes a weight measuring portion that measures at least a weight of the ink stored in an ink container, and an ink refilling pump that extracts the ink from a refill container capable of refilling the ink to the ink container and refills the ink to the ink container; wherein the controller controls the ink refilling pump to refill the ink from the refill container to the ink container, when the weight of the ink measured by the weight measuring portion becomes smaller than or equal to a set value which is predetermined; and the set value is changeable.

According to the disclosure described in (1), the ink can be refilled from the refill container to the ink container when the weight of the ink becomes smaller than or equal to a set value determined by the user. If the weight measuring portion for measuring the weight of the stored ink is arranged and the ink is refilled to the ink container based on the weight, or the measurement value, an effect in that the ink can be more accurately and appropriately refilled than the conventional art can be obtained. Therefore, even when the shaping device is continuously operated for a few days, a beneficial effect in that the ink does not need to be manually added to the ink container in mid-course can be obtained. Furthermore, as the set value can be changed, an effect in that the user can change the conditions of ink refill according to the type of ink is obtained. Moreover, for example, when the ink container includes a liquid level detecting instrument of ink, an extremely beneficial effect in that the timing to carry out the ink refill can be freely and easily changed merely through software change is obtained according to the present disclosure of measuring the weight of the ink, compared to the case where changing the height of the liquid level to carry out the ink refill has limitations to some extent. Furthermore, an effect of being able to respond to the difference in the consumption frequency for each type of ink by the bias of the shaping content of the user (colorless three-dimensional object, single color three-dimensional object, full color three-dimensional object, use of color ink to interior of three-dimensional object, etc.) can be also obtained.

(2) The present disclosure provides the shaping device according to (1), where the plurality of ink supplying systems at least include: a first ink supplying system that supplies a first ink, and a second ink supplying system that supplies a second ink different from the first ink; and a first set value set with respect to the first ink supplying system is relatively smaller than a second set value set with respect to the second ink supplying system.

In the case of a three-dimensional object in which an entire volume is large and an extremely long layering time is required, large amounts of ink are assumed to be consumed, and thus consideration is made to prepare, for inks of all colors, an ink container having a large capacity corresponding to the amount of ink of the ink predicted to have the maximum consumption amount among the ink of each color for all the inks. However, depending on the shaping target, a large difference is considered to arise in the consumption amount among a few types of inks used for the shaping. For example, the consumption amount of the ink of the so-called process color, to be described later, sometimes becomes incommensurably small compared to the consumption amount of the white ink, for example, used for the shaping of the interior of the three-dimensional object, that is, the shaping of the structural body that determines the shape. If the inks of each color are all stored in the ink container having a large capacity in accordance with the ink to be consumed in large amounts, the time the ink of the process color retains in the ink container that is greatly exposed to air, which becomes the cause of deterioration, becomes extremely long.

According to the disclosure described in (2), a light weight set value is set for the set value or the condition of ink refill for the first ink, which is used only by a small amount, so that adjustment is made to consume the ink without passing the expiration date of the ink after opening, and a heavy weight set value is set for the set value or the condition of ink refill for the second ink, which is used in large amounts in a short period of time, so that the ink can be frequently refilled to the ink container.

(3) The present disclosure provides the shaping device according to (2), where the first set value is greater than or equal to 1/20 of the second set value, and the first set value is smaller than or equal to ½ of the second set value.

When realizing the inkjet type shaping device capable of coloring in full color, shaping is carried out by combining the inks of C (Cyan), M (Magenta), Y (Yellow), K (Key Plate: black) (hereinafter abbreviated to CMYK), so-called process colors. In this case, the ink of the process color is often used only by a small amount (e.g., amount of greater than or equal to 1/20 and smaller than or equal to ½) compared to the white ink of when using the white ink to produce a portion, which is a base of the coloring ink and also a structural body, and only an amount of about 1% of the white ink may be used in the ink of one type of the process colors.

According to the disclosure described in (3), assuming the ink of the process color is the first ink and the ink having a large usage amount other than the ink of other than the process color is the second ink, the first set value is set to, for example, greater than or equal to 1/20and smaller than or equal to ½ of the second set value for the set value serving as a reference of ink refill, so that an effect in that the ink is frequently refilled to the ink container of the ink used in large amounts in a short period of time, and the refilling frequency and the refilling amount can be adjusted for the ink container of the process color, which is merely used by a relatively small amount, so that the ink can be consumed without passing the expiration date of the ink after opening is obtained.

(4) The present disclosure provides the shaping device described in (2) or (3), where a capacity of the ink container used in the first ink supplying system and a capacity of the ink container used in the second ink supplying system are substantially equal.

According to the disclosure described in (4), the ink can be switched to an ink of a type different from the normal time on a temporary basis and used with respect to each ink supplying system that normally supplies a predetermined ink since the ink container of the same capacity can be used, and for example, even if one ink supplying system breaks down, output can be made with just other ink supplying systems in emergencies. Furthermore, as the ink container of the same shape and the same capacity can be used, an effect in that the sourcing cost of the ink container can be reduced from the mass production effect, thus contributing to lower price as a whole can be obtained.

In the shaping device that carries out a three-dimensional shaping, a container that can refill the ink container is desirably used rather than simply using a large ink container to more appropriately carry out the continuous operation for a long period of time. This is to prevent the ink from deteriorating by being exposed to air, as described above, and furthermore, to enable an appropriate operation regardless of the past usage history of the ink. In other words, at the time point of starting the shaping, the amount of ink in each ink container may differ depending on the color and the type due to the past history, that is, the content of shaping carried out before the current shaping. Thus, even if the ink container having a large capacity is used, the remaining amount may be small for some inks. In order to handle such event, consideration may be made to fill the ink containers for all the colors up to the capacity limit before the start of shaping, but the problem of deterioration described above occurs. Therefore, the ink container is desirably not only large but can also be refilled. In this case, the capacity of the refill container may differ depending on the color and the type of ink. Moreover, using the ink container that cannot be refilled is not desirable in carrying out the continuous operation for a long period of time because when the ink is used up, the shaping needs to be stopped once and the ink container needs to be replaced.

(5) The present disclosure provides the shaping device described in any one of (2) to (4), where the three-dimensional object colored using a plurality of coloring inks different from each other is shapeable; the first ink is the coloring ink; and the second ink is a white ink.

According to the disclosure described in (5), when the coloring ink is used as the first ink and the white ink is used as the second ink, a white ink of greater than or equal to a predetermined thickness is provided on at least an inner side of the coloring ink, so that light transmitted through the coloring ink from the outside is reflected, and an effect in that a multi-color three-dimensional object by subtractive color mixing method can be shaped is obtained. Furthermore, the white ink may sometimes be used as an ink for structural body shaping that determines the shape of the structural body on the inner side.

(6) The present disclosure provides the shaping device described in any one of (2) to (4), where the three-dimensional object colored using a plurality of coloring inks different from each other is shapeable; the first ink is the coloring ink; and the second ink is an ink to become a material of a support layer that supports the three-dimensional object being shaped.

According to the disclosure described in (6), the ink to become the material of the support layer, which is the material that can be removed after the shaping, can be used in large amounts as the second ink, and thus a beneficial effect in that the shaping of the overhanging shape, that is, the shape in which the layer on the vertically upper side is wider than the layer on the vertically lower side for the two layered layers can be carried out easily without the risk of running out of ink may be obtained.

(7) The present disclosure provides the shaping device described in any one of (2) to (4), where the three-dimensional object colored using a plurality of coloring inks different from each other is shapeable; the first ink is the coloring ink; and the second ink is a clear ink, which is a clear colored ink.

The clear ink is sometimes used greatly depending on the properties of the three-dimensional object. For example, a transparent protective layer may be formed on an outermost portion of the three-dimensional object, that is, the outer side of the colored layer. Furthermore, a clear layer may be provided between the white layer and the colored layer as a separation layer for preventing the inks from mixing. Moreover, when shaping an object having weak strength, such as a thin line form or thin film form, an object entirely buried in the clear ink may become the three-dimensional object. In this case, the clear ink is consumed in large amounts compared to, for example, the ink of the process color for the colored layer.

According to the disclosure described in (7), the clear ink can be used as the second ink, and thus a beneficial effect in that the three-dimensional object, which is a clear color as a whole, can be shaped easily without the risk of running out of ink may be obtained.

(8) The present disclosure provides the shaping device described in any one of (1) to (7), further including: an ink circulating path through which the ink circulates; where in the ink circulating path, a sub-tank that is arranged in a vicinity of the inkjet head to store the ink and that refills the ink to the inkjet head, a three-way valve that switches an input from a first and a second inlets and outputs to one outlet; a first flow path arranged on a side of the outlet and connected with an ink pump that sends the ink to the sub-tank, a supplying path arranged on a side of the first inlet and supplies the ink from the ink container, and a second flow path arranged on a side of the second inlet and returns the ink from the sub-tank are arranged; and in the sub-tank, a liquid level detection sensor that detects a liquid level of the ink in the sub-tank is arranged, and the controller switches the input of the three-way valve based on a measurement value of the liquid level detection sensor.

According to the disclosure described in (8), the inkjet head includes the sub-tank for storing a small amount of ink, and the ink pressure in the sub-tank is controlled, so that a beneficial effect in that the ink pressure in the vicinity of the nozzle of the inkjet head can be easily adjusted is obtained. Furthermore, an extremely beneficial effect is obtained in that the shaping device in which the influence on the ink supply is small even during the shaping can be realized by having the ink supplying system that supplies the ink from the ink container and the ink circulating path independent by way of the three-way valve and arranging the sub-tank for buffering.

(9) The present disclosure provides the shaping device according to (8), further including: an air pressure adjusting pump that changes an air pressure in the sub-tank; where the controller controls the air pressure adjusting pump to adjust a pressure of supplying ink from the sub-tank to the inkjet head.

The air pressure in the sub-tank is made to a negative pressure to prevent extra ink from dripping from the nozzle of a predetermined color while the shaping by the ink of the relevant color is stopped. According to the disclosure described in (9), the air pressure adjusting pump that changes the air pressure in the sub-tank is further arranged, where the controller controls the air pressure adjusting pump to adjust the pressure of supplying ink from the sub-tank to the inkjet head, and hence a beneficial effect of preventing ink from dripping is obtained by easily making the air pressure in the sub-tank to a negative pressure and the ink pressure in the vicinity of the nozzle to a negative pressure. Furthermore, even during the ink supply from the ink supplying system, the air pressure in the sub-tank can be controlled accurately, and thus an extremely beneficial effect in that the ink pressure in the vicinity of the nozzle of the inkjet can be maintained constant can be obtained.

(10) The present disclosure provides the shaping device according to (8) or (9), where a deaerating module that carries out deaeration of the ink is arranged in the ink circulating path.

In the inkjet head, air bubbles easily grow inside the nozzle due to the cavitation effect in which microscopic air bubbles generate when pressurization and depressurization are repeated over a great number of times during the ink eject. Furthermore, the air always exists in the sub-tank and the air is also accumulated at the upper part of the ink container, and a surface area of the ink exposed to air is large particularly in a large ink container. When exposed to air, the ink dissolves the air therein, and further grows the air bubbles by cavitation, which may become the cause of nozzle clogging and lowering in the accuracy of droplet landing position by the absorption of discharging pressure by the air bubbles. When using an ultraviolet curing type ink for the ink, problems such as inhibitation of polymerization may occur when the ink is exposed to the air depending on the composition of the ink. According to the disclosure described in (10), as the deaerating module for carrying out deaeration of the ink is arranged in the ink circulating path, the ink, in which the air is dissolved, is deaerated in the ink circulating path so that the air bubbles are less likely to grow, and hence a beneficial effect in that break down is less likely to occur is obtained.

(11) The present disclosure provides the shaping device described in any one of (7) to (10), where in the ink circulating path, a first sub-tank arranged upstream of the inkjet head, and a second sub-tank arranged downstream of the inkjet head are arranged.

According to the disclosure described in (11), the sub-tank is arranged at the upstream and the downstream of the nozzle of the inkjet head, respectively, so that an effect of being able to easily control the ink pressure in the vicinity of the nozzle is obtained by controlling the air pressure of the respective sub-tank.

(12) The present disclosure provides a shaping device that shapes a stereoscopic three-dimensional object by discharging ink, the shaping device including a plurality of inkjet heads that eject the ink of a color different from each other; a plurality of ink supplying systems that supply a corresponding ink to each of the plurality of inkjet heads; and an ink circulating path through which the ink circulates; where in the ink circulating path, a sub-tank that is arranged in a vicinity of the inkjet head to store the ink and that refills the ink to the inkjet head, a three-way valve that switches an input from a first and a second inlets and outputs to one outlet; a first flow path arranged on a side of the outlet and connected with an ink pump that sends the ink to the sub-tank, a supplying path arranged on a side of the first inlet and supplies the ink from the ink container, and a second flow path arranged on a side of the second inlet and returns the ink from the sub-tank are arranged; a deaerating module that carries out deaeration of the ink is arranged in the ink circulating path; in the sub-tank, a liquid level detection sensor that detects a liquid level of the ink in the sub-tank, and a controller that controls a supply of the ink from the plurality of ink supplying systems to the plurality of inkjet heads are arranged; and the controller switches the input of the three-way valve based on a measurement value of the liquid level detection sensor.

The ink used in the inkjet method easily dissolves the air therein when exposed to air. When using an ink container having a large capacity, the surface area of the ink exposed to the atmosphere becomes large, and furthermore, as the sub-tank is arranged in the inkjet head to store ink and the air pressure is adjusted to adjust the ink pressure in the vicinity of the nozzle, the ink is also exposed to the atmosphere here as well. In addition, when the ink supplied to the inkjet head is circulated, air bubbles are grown by the cavitation effect of the distal end of the nozzle. According to the disclosure described in (12), as the deaerating module is arranged in the ink circulating path to carry out deaeration, a beneficial effect in that air bubbles are less likely to grow and breakdowns such as nozzle clogging are less likely to occur is obtained.

Furthermore, as the air pressure of the sub-tank can be adjusted, the air pressure of the sub-tank can be controlled accurately even during the ink supply, and an extremely beneficial effect in that the ink pressure in the vicinity of the nozzle of the inkjet can be maintained constant can be obtained.

Moreover, an extremely beneficial effect can be obtained in that the shaping device in which the influence on the ink supply is small even during the shaping can be realized as a control of having the ink supplying system that supplies the ink from the ink container and the ink circulating path independent by way of the three-way valve can be carried out and the sub-tank for buffering is arranged.

(13) The present disclosure provides a shaping method that shapes a stereoscopic three-dimensional object by discharging ink, where with respect to a plurality of inkjet heads that eject the ink of a color different from each other, and a plurality of ink supplying systems that supply a corresponding ink to each of the plurality of inkjet heads; the shaping method includes: controlling a supply of the ink from the plurality of ink supplying systems to the plurality of inkjet heads; measuring at least a weight of the ink stored in an ink container; extracting the ink from a refill container capable of refilling the ink to the ink container and refilling the ink to the ink container; and controlling an ink refilling pump to refill the ink from the refill container to the ink container, when the weight of the ink measured by a weight measuring portion becomes smaller than or equal to a set value which is predetermined; where the set value is changeable.

According to the disclosure described in (13), the weight of the stored ink can be measured, and the control can be made to refill the ink from the refill container to the ink container based on the weight. The timing to refill the ink can be determined by setting a threshold value for the weight to measure. In other words, the ink can be refilled from the refill container to the ink container when the weight of the ink becomes smaller than or equal to a predetermined set value, so that a beneficial effect in that both the ink can be prevented from running out and the deterioration of the ink can be prevented as low as possible is achieved by selecting an appropriate set value in view of the consumption amount of the ink and the deterioration of the ink that occurs when the ink is stored in the ink container.

(14) The present disclosure provides the shaping method according to claim 13, where with respect to at least a first ink supplying system that supplies a first ink and a second ink supplying system that supplies a second ink different from the first ink, a first set value set with respect to the first ink supplying system is relatively smaller than a second set value set with respect to the second ink supplying system.

A case where the ink of the process color, for example, which is used only by a small amount, is the first ink, and the white ink, for example, for structural body shaping having a high possibility of using a large amount of ink in a short period of time, is the second ink is considered. According to the disclosure described in (14), a beneficial effect is obtained in that a light weight set value is set for the set value or the condition of ink refill for the first ink, which is used only by a small amount, so that adjustment is made to consume the ink without passing the expiration date of the ink after opening, and a heavy weight set value is set for the set value or the condition of ink refill for the second ink, which is used in large amounts in a short period of time, so that the ink is frequently refilled to the ink container.

The shaping methods of (13) and (14) can also be considered as a manufacturing method of a three-dimensional object.

According to the shaping device and the shaping method described in claims 1 to 14 of the present disclosure, the ink can be refilled from the refill container to the ink container when the weight of the ink becomes smaller than or equal to a set value determined by the user. If the weight measuring portion for measuring the weight of the stored ink is arranged and the ink is refilled to the ink container based on the weight, or the measurement value, an effect in that the ink can be more accurately and appropriately refilled than the conventional art can be obtained. Therefore, even when the shaping device is continuously operated for a few days, the ink does not need to be manually added to the ink container in mid-course, and the shaping can be continued without considering running-out of the ink. Furthermore, a large amount of ink does not need to be wastefully stored in the ink container, and hence a beneficial effect in that the ink can be prevented as low as possible from deteriorating by being exposed to air in the ink container is obtained. Moreover, as the set value can be changed, a beneficial effect in that the user can freely change the conditions of ink refill according to the type of ink is obtained.

### BRIEF DESCRIPTION OF THE DRAWINGS

FIG. 1 is a block diagram of a shaping device according to an embodiment of the present disclosure;

FIG. 2 is a detailed explanatory view of the shaping device;

FIG. 3 is an explanatory view of an ink supplying system;

FIG. 4 is an explanatory view of an ink circulating system;

FIG. 5 is an explanatory view of an air supplying controller;

FIG. 6A is an explanatory view describing a connection of a three-way valve;

FIG. 6B is an explanatory view of a plurality of sub-tanks in a carriage and a plurality of nozzles connected thereto in the shaping device according to the embodiment of the present disclosure; and FIG. 6C is an explanatory view of a liquid level detecting operation in the sub-tank;

FIG. 7 is a chart describing an air pressure control in the sub-tank;

FIG. 8A is a chart describing a negative pressure holding control by the air supplying controller; and FIG. 8B is a graph describing a temporal change in pressure in the two sub-tanks;

FIG. 9A is an explanatory view of an operation of positive pressure controlling the sub-tank and carrying out purge; FIG. 9B is an explanatory view of a state in which the sub-tank is negative pressure controlled after the purge; and FIG. 9C is a charge explaining a positive pressure holding control by the air supplying controller; and

FIG. 10A is a schematic view of a shaping device by an inkjet method; and FIG. 10B is a cross-sectional view of a three-dimensional object colored by the inkjet method.

### DESCRIPTION OF EMBODIMENTS

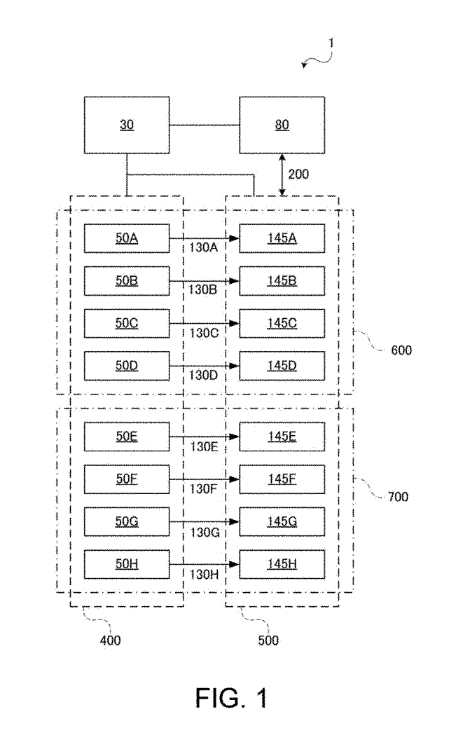

Hereinafter, an embodiment of the present disclosure will be described with reference to the accompanying drawings. FIG. 1 to FIG. 9C show one example of a mode for carrying out the disclosure, where portions denoted with the same reference numerals represent the same object in the figures. In each figure, some configurations are appropriately omitted to simplify the drawings. The size, shape, thickness, and the like of a member are appropriately expressed in an exaggerated manner.

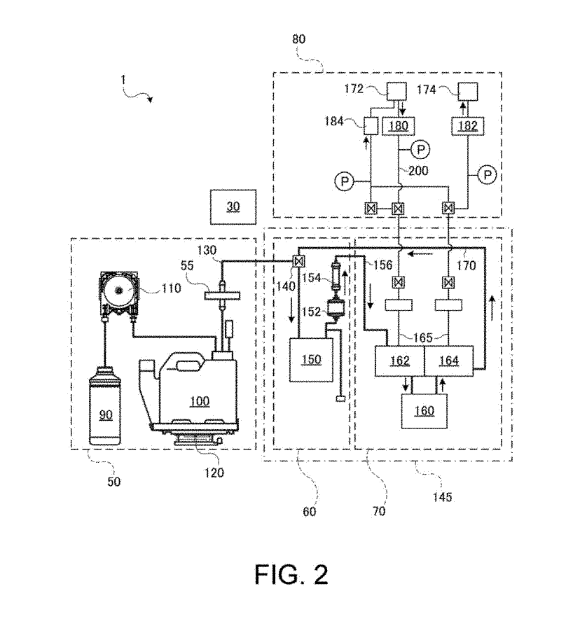

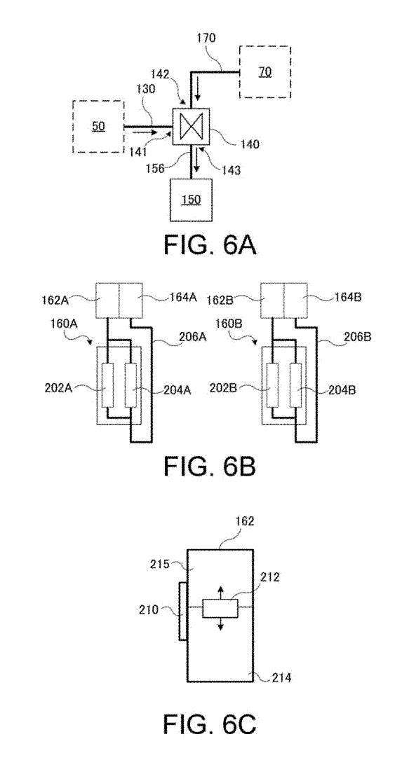

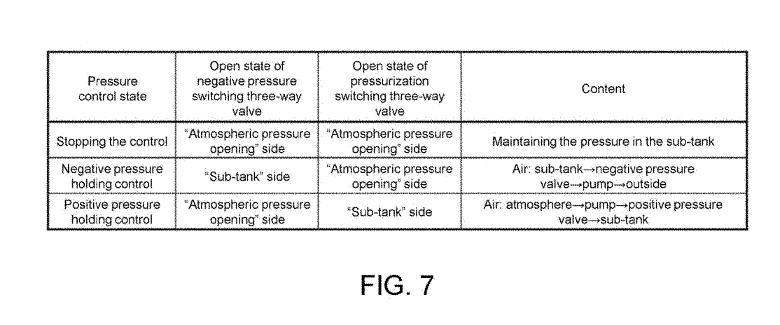

FIG. 1 is a block diagram describing an overall image of the shaping device 1 according to an embodiment of the present disclosure. The shaping device 1 is a shaping device that shapes a stereoscopic three-dimensional object by discharging ink, and includes a plurality of inkjet heads 160 (see FIG. 2, FIG. 6B) that eject ink of a color different from each other. The inkjet head 160 is held by a carriage 70 (see FIG. 2), and is scanned to carry out shaping. A plurality of ink supplying systems 50 and the like that supply a corresponding ink are connected to the plurality of inkjet heads 160. That is, as shown in FIG. 1, the shaping device 1 includes an ink supplying portion 400 provided with the plurality of ink supplying systems 50 that supply a corresponding ink to each of the inkjet heads 160, and an ink circulating portion 500 provided with a plurality of ink circulating paths 145 through which the corresponding ink circulates. In the ink circulating portion 500, an air pressure in a sub-tank 162 and a sub-tank 164, to be described later, is controlled by at least one air supplying controller 80 through an air path 200, and consequently, an ink pressure in the vicinity of a nozzle in the inkjet head 160 is accurately adjusted. The ink supplying portion 400, the ink circulating portion 500, and the air supplying controller 80 are appropriately controlled by the controller 30.

The controller 30 is configured by CPU, RAM, ROM, and the like, and executes various types of control. The CPU is a so-called arithmetic processing device, and realizes various functions by executing various types of programs. The RAM is used as a work region or a storage region of the CPU, and the ROM stores an operating system and programs to be executed by the CPU.

For example, eight ink supplying systems 50, that is, an ink supplying system 50A to an ink supplying system 50H, are arranged for every ink of a color different from each other in the ink supplying portion 400. The respective ink supplying system 50A to ink supplying system 50H is connected to each of the eight ink circulating path 145A to ink circulating path 145H, for example, by way of a supplying path 130A to a supplying path 130H for the corresponding ink. Here, assuming an ink group of four colors of which the consumption amount is relatively small at the time of shaping, as a first ink, and an ink of a color different from the first ink as a second ink, the ink supplying portion 400 and the ink circulating portion 500 are respectively classified as a first ink system 600 and a second ink system 700. In other words, for example, the coloring ink of each of CMYK, which are process colors, are assumed as the first ink system 600, and for example, white ink, clear ink, and ink serving as a material of the support layer are assumed as the second ink system 700.

The coloring ink is an ink of each color of CMYK or each color of a so-called process color. Furthermore, the coloring ink is a basic color for expressing full color with a subtractive color mixture. In other words, the coloring ink is a plurality of chromatic colors and a black ink. The white ink is an ink used in forming a region having a light reflecting property necessary for the subtractive color mixing method in the interior of the three-dimensional object, and is an ink at least disposed on the inner side of the coloring layer.

FIG. 2 is a detailed explanatory view of the shaping device 1. For simplification, however, an explanatory view of the ink supplying system 50, the ink circulating path 145, and the air supplying controller 80 for an ink of one of a plurality of colors is shown herein. One air supplying controller 80 is commonly arranged with respect to the plurality of ink circulating paths 145. In other words, for example, the control of ink pressure is carried out with only one air supplying controller 80 with respect to, for example, eight ink circulating paths 145. Needless to say, the air supplying controller 80 corresponding to the respective color may be arranged with respect to the respective ink circulating path 145, and for example, one air supplying controller 80 may be arranged for the first ink system 600 (see FIG. 1) and one air supplying controller 80 may be arranged for the second ink system 700 (see FIG. 1). The shaping device 1 includes the ink supplying system 50 that supplies ink, the ink circulating path 145 through which the ink circulates, the air supplying controller 80 that controls the ink pressure, and the controller 30 that carries out the control of the entire shaping device 1. A carriage 70 for holding at least one part of the ink circulating path 145 and the inkjet head 160, and the like are arranged.

Briefly, the ink supplying system 50 supplies ink to the inkjet head 160 through the supplying path 130, an ink path controller 60 controls the flow of ink in the ink path, and the air supplying controller 80 controls the ink pressure in the inkjet head. The controller 30 controls the entire shaping device 1.

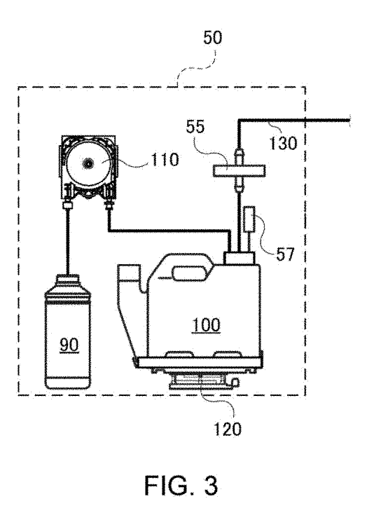

FIG. 3 is an explanatory view of the ink supplying system 50 for an ink of one color. Here, the ink supplying system 50 for an ink of one color of the eight ink supplying systems will be described for simplification. The ink supplying system 50 includes an ink container 100 storing ink, a weight measuring portion 120 that measures a weight of the ink stored in the ink container 100, a refill container 90 capable of refilling ink to the ink container 100, and an ink refilling pump 110 that extracts ink from the refill container 90 capable of refilling ink to the ink container 100 and refills ink to the ink container 100. The controller 30 (see FIG. 2) controls the ink refilling pump 110 to refill ink from the refill container 90 to the ink container 100 when the weight of the stored ink measured by the weight measuring portion 120 becomes smaller than or equal to a predetermined set value. The predetermined set value can be changed in advance by a user.

The weight measuring portion 120 measures at least the weight of the ink herein, where a method therefor may be appropriately selected. For example, measuring in advance the weight of the ink container 100 for storing ink in an empty state is considered. The weight of the entire ink container 100 in an ink storing state may be measured by the weight measuring portion 120 during the operation of the shaping device 1, and the weight of the ink container 100 in an empty state measured in advance may be subtracted therefrom to obtain the weight of the ink. Furthermore, if the ink container 100 of the same weight is always used, a set value may be provided for a weight combining the weight of the ink and the weight of the ink container 100, and the ink may be supplied from the refill container 90 to the ink container 100 based on the set value.

A filter 55 for passing the ink may be arranged on an outlet side path of the ink container 100, and the ink supplying system 50 and the ink path controller 60 are connected by a supplying path 130, which is a path for supplying ink to the ink path controller 60, thus realizing the supply of the ink. The supplying path 130, to be described later, is arranged at a connecting part to make the ink supplying system 50 and the ink circulating path 145 independent.

A stirring portion 57 for stirring ink is arranged in at least the ink container 100 for white ink to stir the ink in the container.

For example, assuming the first ink is a coloring ink of each of CMYK, which are process colors, and the second ink is the white ink, the clear ink, the ink serving as a material of the support layer, and the like (see FIG. 1), a first set value set with respect to the first ink supplying system for supplying the first ink is, for example, smaller than a second set value set with respect to the second ink supplying system for supplying the second ink, or the white ink. Specifically, the first set value is, for example, greater than or equal to 1/20 and smaller than or equal to ½ of the second set value. Needless to say, each set value may be appropriately set by the user according to the type of ink.

Furthermore, a capacity of the ink container 100 used in the first ink supplying system 50A to the ink supplying system 50D and a capacity of the ink container 100 used in the second ink supplying system 50E to the ink supplying system 50H are substantially equal to each other.

According to the shaping device 1 of the embodiment of the present disclosure, the ink can be refilled from the refill container to the ink container when the weight of the ink becomes smaller than or equal to a set value determined by the user. If the weight measuring portion 120 for measuring the weight of the stored ink is arranged and the ink is refilled to the ink container 100 based on the weight, or the measurement value, an effect in that the ink can be more accurately and appropriately refilled than the conventional art can be obtained. Therefore, even if the shaping device 1 is continuously operated for a few days, a beneficial effect in that the ink does not need to be manually added to the ink container 100 in mid-course can be obtained. Furthermore, as the set value can be changed, an effect in that the user can change the conditions of ink refill according to the type of ink is obtained. Moreover, for example, when the ink container includes a liquid level detecting instrument of ink, an extremely beneficial effect in that the timing to carry out the ink refill can be freely and easily changed merely through software change is obtained according to the present disclosure of measuring the weight of the ink, compared to the case where changing the height of the liquid level to carry out the ink refill has limitations to some extent.

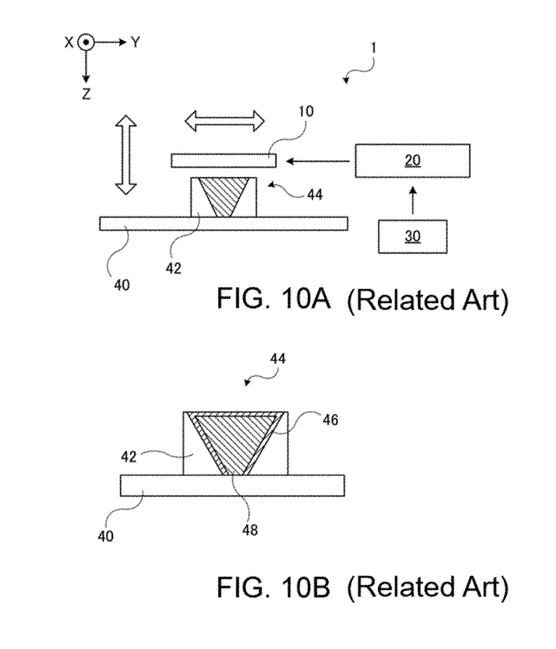

In the case of a three-dimensional object 44 (see FIGS. 10A and 10B) in which an entire volume is large and an extremely long layering time is required, large amounts of ink is assumed to be consumed, and thus consideration is made to prepare the ink container 100 having a large capacity corresponding to the ink predicted to have the maximum consumption amount among all the inks for the inks of all colors. However, depending on the shaping target, a large difference is considered to arise in the consumption amount among a few types of inks used for the shaping. For example, the consumption amount of the ink of the so-called process color sometimes becomes incommensurably small compared to the consumption amount of the white ink, for example, used for the shaping of the interior of the three-dimensional object 44, that is, the shaping of the structural body that determines the shape. If all the ink of each color is stored in the ink container 100 having a large capacity in accordance with the ink to be consumed in large amounts, the time the ink of the process color retains in the ink container 100 that is greatly exposed to air, which becomes the cause of deterioration, becomes extremely long.

According to the shaping device 1 of the embodiment of the present disclosure, a light weight set value is set for the set value or the condition of ink refill for the first ink, only a small amount of which is used, and adjustment is made to consume ink without passing the expiration date of the ink after opening, and a heavy weight set value is set for the set value or the condition of ink refill for the second ink, large amounts of which is used in a short period of time, and ink is frequently refilled to the ink container 100.

When realizing an inkjet type shaping device capable of coloring in full color, the ink of CMYK, which are process colors, are combined for shaping. In this case, the ink of the process color is often used only by a small amount (e.g., amount of greater than or equal to 1/20 and smaller than or equal to ½) compared to the white ink used for shaping a portion, which is a light reflective layer of the coloring ink and also a structural body, and only an amount of about 1% of the white ink is sometimes used in the case of an ink of one color.

According to the shaping device 1 of the embodiment of the present disclosure, assuming the ink of the process color is the first ink and the white ink is the second ink, the first set value is set to, for example, greater than or equal to 1/20 and smaller than or equal to ½ of the second set value for the set value serving as a reference of ink refill, so that an effect in that the ink is frequently refilled to the ink container of the white ink, which is used in large amounts in a short period of time, and the refilling frequency and the refilling amount can be adjusted for the ink container of the process color, which is merely used by a relatively small amount, so that the ink can be consumed without passing the expiration date of the ink after opening is obtained.

According to the shaping device 1 of the embodiment of the present disclosure, the ink can be switched to an ink of a type different from the normal time on a temporary basis and used with respect to each ink supplying system 50 that normally supplies a predetermined ink since the ink container 100 of the same capacity can be used, and for example, even if one ink supplying system 50 breaks down, output can be made with just other ink supplying systems 50 in emergencies. Furthermore, as the ink container 100 of the same shape and the same capacity can be used, an effect in that the sourcing cost of the ink container 100 can also be reduced from the mass production effect, thus contributing to lower price as a whole can be obtained.

In the shaping device 1 that carries out a three-dimensional shaping, a container that can refill the ink container 100 is desirably used rather than simply using a large ink container 100 to more appropriately carry out the continuous operation for a long period of time. This is to prevent the ink from deteriorating by being exposed to air, as described above, and furthermore, to enable an appropriate operation regardless of the past usage history of the ink. In other words, at the time point of starting the shaping, the amount of ink in each ink container 100 may differ depending on the color due to the past history, that is, the content of shaping carried out before the current shaping. Thus, even if the ink container 100 having a large capacity is used, the remaining amount may be small for the inks of some colors. In order to handle such event, consideration is made to fill the ink containers 100 of all the colors up to the capacity limit before the start of shaping, but the problem of deterioration described above occurs. Therefore, the ink container 100 is desirably not only large but can also be refilled. In this case, the capacity of the refill container 90 may differ depending on the color and type of ink. Moreover, using the ink container 100 that cannot be refilled is not desirable in carrying out the continuous operation for a long period of time because when the ink is used up, the shaping needs to be stopped once and the ink container 100 needs to be replaced.

According to the shaping device 1 of the embodiment of the present disclosure, the ink can be switched to an ink of a type different from the normal time on a temporary basis and used with respect to each ink supplying system 50 that normally supplies a predetermined ink since the ink container 100 of the same capacity can be used, and for example, even if one ink supplying system 50 breaks down, output can be made with just other ink supplying systems 50 in emergencies. Furthermore, as the ink container 100 of the same shape and the same capacity can be used, an effect in that the sourcing cost of the ink container 100 can also be reduced from the mass production effect, thus contributing to lower price as a whole can be obtained.

According to the shaping device 1 of the embodiment of the present disclosure, an effect in that a multi-colored three-dimensional object can be shaped by using the coloring ink for the first ink and forming a layer of white ink on the inner side of the coloring ink as the second ink is obtained. Furthermore, the white ink is sometimes used as an ink for structural body shaping that determines the shape of the structural body.

According to the shaping device 1 of the embodiment of the present disclosure, the ink to become the material of the support layer, which is the material that can be removed after the shaping, can be used in large amounts as the second ink, and thus a beneficial effect in that the shaping of the overhanging shape, that is, the shape in which the layer on the vertically upper side is wider than the layer on the vertically lower side for the two layered layers can be carried out easily without the risk of running out of ink may be obtained.

The clear ink is sometimes used greatly depending on the properties of the three-dimensional object. For example, a transparent protective layer may be formed on an outermost portion of the three-dimensional object, that is, the outer side of the colored layer. Furthermore, a clear layer may be provided between the white layer and the colored layer as a separation layer for preventing the inks from mixing. Moreover, when shaping an object having weak strength, such as a thin line form or thin film form, an object entirely buried in the clear ink may become the three-dimensional object. In this case, the clear ink is consumed in large amounts compared to, for example, the ink of the process color for the colored layer.

According to the shaping device 1 of the embodiment of the present disclosure, the clear ink can be used as the second ink, and thus, a beneficial effect in that the three-dimensional object, which is transparent as a whole, can be shaped easily without the risk of running out of ink may be obtained.

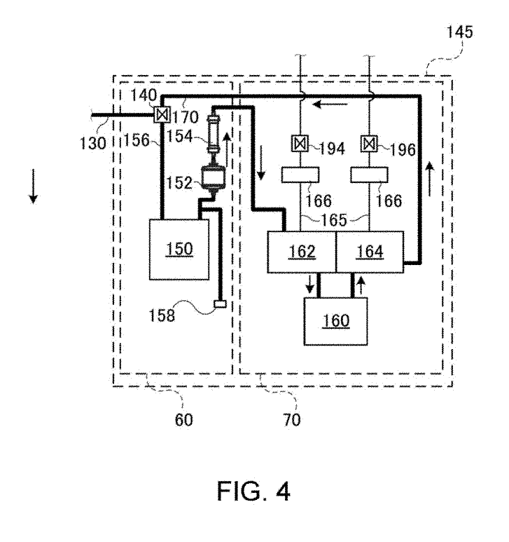

The ink circulating path 145 through which the ink circulates will now be described with reference to FIG. 4. The ink circulating path 145 for one ink of the eight ink circulating paths will be described below for simplification. In the ink circulating path 145, the ink path controller 60 that controls the ink path, a first flow path 156 including the ink path controller 60, a carriage 70 that holds the inkjet head 160, a second flow path 170 continuing from the carriage 70, and a three-way valve 140, which is a branching point of the supplying path 130 connecting the ink supplying system 50 and the ink circulating path 145 are arranged.

First, the ink path controller 60 will be described.

The ink supplied from the ink supplying system 50 in the ink path controller 60 is sent from the three-way valve 140 to the ink pump 150. The operation of the three-way valve 140 of switching the input from the two inlets and outputting to one outlet will be described in detail in FIG. 6A. The ink path controller 60 includes the three-way valve 140, the first path 156, which constitutes one part of the ink circulating path 145 arranged on the outlet side of the three-way valve 140 and connected with the ink pump 150 that sends the ink to the sub-tank 162, the filter 152 that does not pass through dust in the ink and agglomerated and coarsened pigments by passing through the ink, and a deaerating module 154. An ink eject port 158 is provided by being branched from the flow path directed toward the first sub-tank 162 in the vicinity of the ink pump 150.

In the entire ink flow path, the flow path of a hollow fiber inside the deaerating module 154 and the nozzle of the inkjet head 160 is narrow, in particular, and hence the filter 152 is disposed upstream of the deaerating module 154. Therefore, the filter 152 and the deaerating module 154 are desirably arranged in order toward the first sub-tank 162 side when seen from the ink pump 150 in the first flow path 156.

Next, the carriage 70 will be described. The carriage 70 holds the inkjet head 160. The carriage 70 is arranged with the first sub-tank 162, to which the first flow path 156 is connected, the inkjet head 160 including a nozzle (see FIG. 6B to be described later) for discharging ink, the second sub-tank 164 arranged downstream of the inkjet head 160, and the second flow path 170 for circulating the ink from the second sub-tank 164 to the three-way valve 140. The first sub-tank 162 and the second sub-tank 164 are arranged in the vicinity of the inkjet head 160, that is, for example, arranged in the carriage 70 to store ink, and refill the ink to the inkjet head 160.

Furthermore, the air path 165 for controlling air pressure is connected to the first sub-tank 162 and the second sub-tank 164, the air path 165 being connected to the air supplying controller 80. The air path 165 includes a back flow preventing filter 166 that prevents ink from accidentally flowing back and prevents dust in the air from entering the sub-tanks 162, 164, an upstream two-way valve 194, and a downstream two-way valve 196.

In the shaping device 1 according to the embodiment of the present disclosure that carries out a three-dimensional shaping, ink is used in large amounts, and thus the ink container 100 is not mounted on the carriage 70, thus realizing lighter weight of the carriage 70 and enabling high speed shaping. Arranging the ink container 100 integrated with the inkjet head 160 on the carriage 70 has a merit in that the adjustment of the ink pressure is easy, but has a demerit in that increasing the shaping speed is difficult as a large energy is required for scanning if a large and heavy container is mounted for the ink container 100. In the shaping device 1 according to the present embodiment in which the path between the ink container 100 and the inkjet head 160 becomes long, the ink pressure is appropriately controlled by the air supplying controller 80, as will be described later.

Furthermore, the shaping device 1 includes the first sub-tank 162 arranged upstream of the inkjet head 160, and the second sub-tank 164 arranged downstream of the inkjet head 160 in the ink circulating path 145. According to such structure, the flow in which the ink circulates from the first sub-tank 162 to the second sub-tank 164 through the inkjet head 160 is realized, and the ink pressure in the inkjet head 160 can be adjusted by increasing the air pressure in the first sub-tank 162 to be higher than the air pressure in the second sub-tank 164.

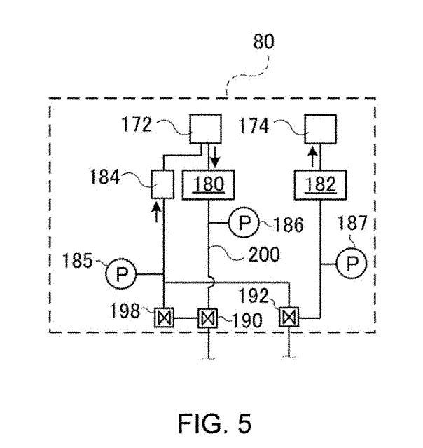

FIG. 5 is an explanatory view of the air supplying controller 80. The air supplying controller 80 is connected to the carriage 70 by way of the air path 165 (see FIG. 4), and controls the air pressure of the first sub-tank 162 and the second sub-tank 164 to indirectly adjust the ink pressure. In other words, the shaping device 1 further includes a first sub-tank side air pressure adjusting pump 172 and a second sub-tank side air pressure adjusting pump 174 as an air pressure adjusting pump for changing the air pressure in the sub-tank, where the controller 30 controls the first sub-tank side air pressure adjusting pump 172 and the second sub-tank side air pressure adjusting pump 174 to adjust the pressure of supplying the ink from the sub-tank to the inkjet head 160. The air supplying controller 80 includes the first sub-tank side air pressure adjusting pump 172 that carries out a negative pressure control, the second sub-tank side air pressure adjusting pump 174, and a large chamber 180 and a large chamber 182 for preventing rapid change in air pressure. Furthermore, a positive pressure throttle valve 198 for atmospheric opening is arranged, and an upstream three-way valve 190, a downstream three-way valve 192, a positive pressure sensor 185, a negative pressure sensor 186, and a negative pressure sensor 187 are arranged for pressure control by the controller 30. The first sub-tank side air pressure adjusting pump 172 and the second sub-tank side air pressure adjusting pump 174 are commonly used in the plurality of inkjet heads 160. The operation and specific control of the upstream three-way valve 190 and the downstream three-way valve 192 will be described later.

The direction of air during the operation of each pump is indicated with an arrow in FIG. 5. In other words, with respect to the first sub-tank side air pressure adjusting pump 172, the air flows in a direction of pushing the air into the first sub-tank 162 during the pump operation, and with respect to the second sub-tank side air pressure adjusting pump 174, the air flows in a direction of extracting the air from the second sub-tank 164 during the pump operation.

FIG. 6A is an explanatory view describing a connection of the three-way valve 140. The three-way valve 140 switches the input from two inlets, that is, a first inlet and a second inlet, and outputs to one outlet. The first path 156, to which the ink pump 150 for sending the ink to the sub-tank 162 is connected, is connected to the outlet 143 of the three-way valve 140, the supply path 130 for supplying the ink from the ink container 100 is connected to the first inlet 141, and the second flow path 170 for returning the ink from the second sub-tank 164 is connected to the second inlet 142.

While the ink is circulating, the controller 30 closes the first inlet 141 from the supply path 130 and opens the second inlet 142 on the carriage 70 side with respect to the three-way valve 140 and sends the ink from the outlet 143 to the first flow path 156 in the direction of the arrow to carry out a control of circulating the ink. In other words, in the circulating state, the ink circulates in the direction from the ink pump 150 in the first flow path 156, through the first sub-tank 162, the inkjet head 160, and the second sub-tank 164 in such order, and through the second flow path 170 to again return to the ink pump 150. Furthermore, when the ink is supplied from the ink supplying system 50, the controller 30 closes the second inlet 142 on the carriage 70 side and opens the first inlet 141 on the ink supplying system 50 side with respect to the three-way valve 140 to carry out a control of sending the ink in the direction of an arrow from the outlet 143 to the first flow path 156. The supplying time of ink is, for example, within ten seconds. At this time, the ink pump 150 desirably stops the operation once. Through such control, a beneficial effect in that the shaping itself can be continuously carried out even while supplying ink from the ink container 100 is obtained.

FIG. 6B is an explanatory view of a plurality of sub-tanks in the carriage 70 and a plurality of nozzles connected thereto in the shaping device 1 according to the embodiment of the present disclosure. The carriage 70 includes, for example, eight inkjet heads 160 corresponding to the ink of each color. FIG. 6B shows an inkjet head 160A that ejects the first ink, and an inkjet head 160B that ejects the second ink. The inkjet head 160A includes a first nozzle row 202A that ejects the first ink and a second nozzle row 204A, and is connected to a first sub-tank 162A and a second sub-tank 164A, where the ink moves from the first sub-tank 162A to the second sub-tank 164B. The inkjet head 160B ejects the second ink, but has a configuration similar to the inkjet head 160A, and thus the description thereof will be omitted.

In the present embodiment, a configuration in which the first nozzle row 202 and the second nozzle row 204 are combined is considered as the inkjet head 160. In this case, the inkjet head 160 can be considered as, for example, a portion that receives the ink supply from one ink container 100 and ejects the ink, and the like. Furthermore, for example, the configuration corresponding to one nozzle row of the first nozzle row 202 and the second nozzle row 204 may be considered as the inkjet head 160 depending on the manner of dividing the configuration. In this case, the inkjet head 160 in the present embodiment can be considered as a combined head, and the like configured by, for example, a plurality of inkjet heads 160.

The capacity of the first sub-tank 162 and the second sub-tank 164 is about 20 ml, respectively.

FIG. 6C is an explanatory view of a liquid level detecting operation in the sub-tank. The first sub-tank 162 stores ink 214, and includes a liquid level detection sensor 210 to detect a position of a float 212 floating on the liquid level of the ink. An air 215 is provided at the upper part of the ink 214, and connection is made to the air supplying controller 80 through the air path 165. The ink is supplied from the ink supplying system 50 to the ink circulating path 145 when the controller 30 determines that the amount of ink 214 is small based on the detection result of the liquid level detection sensor 210, and the ink is not supplied when the controller 30 determines that the ink 214 is sufficient and the controller 30 carries out a control to circulate the ink. In other words, the liquid level detection sensor for detecting the liquid level of the ink in the sub-tank is provided in the sub-tank, and the controller 30 switches the input of the three-way valve 140 based on a measurement value of the liquid level detection sensor.

Specifically, when the controller 30 detects that the ink in the first sub-tank 162 is small by the liquid level detection sensor 210, the controller 30 closes the second inlet 142 on the carriage 70 side and opens the first inlet 141 on the ink supplying system 50 side in the three-way valve 140 (see FIG. 6A) to supply the ink in the direction of the arrow from the outlet 143 to the first flow path 156. When the controller 30 detects that the amount of ink in the first sub-tank 162 is appropriate by the liquid level detection sensor 210, the controller 30 closes the first inlet 141 on the ink supplying system 50 side and opens the second inlet 142 on the carriage 70 side in the three-way valve 140 to circulate the ink in the direction of the arrow from the outlet 143 to the first flow path 156. According to such configuration, the ink can be supplied from the ink supplying system 50 to the ink circulating path 145 without inhibiting the continuous operation.

In the present embodiment, the liquid level detection sensor 210 is disposed in the first sub-tank 162, but may be disposed in the second sub-tank 164.

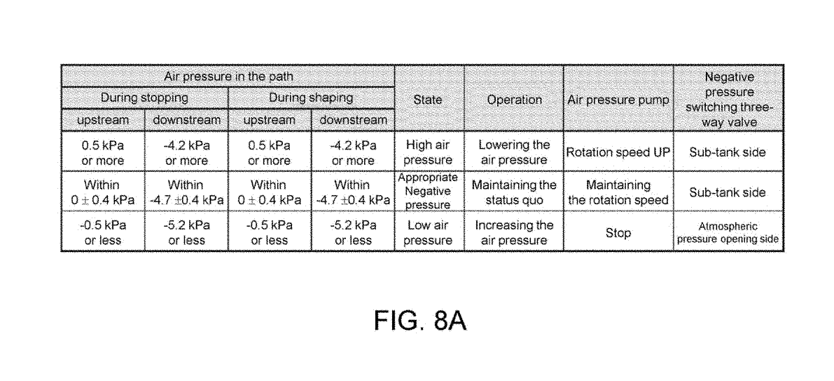

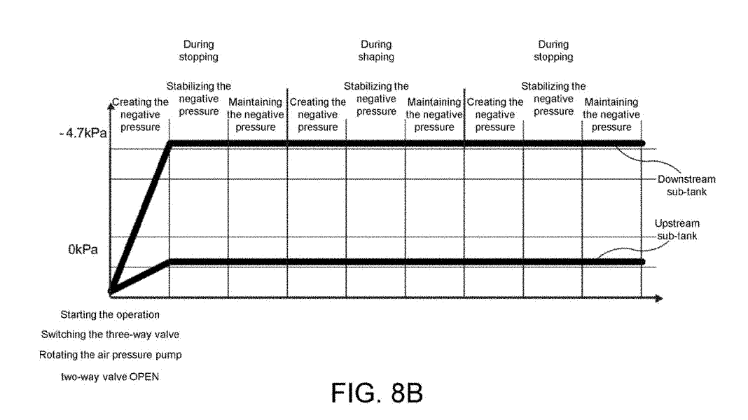

Next, the operation of the embodiment described above will be described with reference to FIGS. 7 and 8.

FIG. 7 is a chart describing an air pressure control in the sub-tank. When maintaining the pressure in the sub-tank in status quo, that is, when stopping the pressure control, the air pressure adjustment in the sub-tank is not carried out, and thus the air path 165 connecting to the air 215 is desirably made to atmospheric pressure. The upstream three-way valve (pressurization switching three-way valve) 190 separates the path from the first sub-tank side air pressure adjusting pump 172, and switches to the positive pressure throttle valve 198 side for atmospheric pressure opening. At the same time, the downstream three-way valve (negative pressure switching three-way valve) 192 also separates the path from the second sub-tank side air pressure adjusting pump 174, and switches to the positive pressure throttle valve 198 side for atmospheric pressure opening. When carrying out the negative pressure holding control, with the upstream three-way valve (pressurization switching three-way valve) 190 switched to the positive pressure throttle valve 198 side for atmospheric pressure opening, the downstream three-way valve (negative pressure switching three-way valve) 192 separates the positive pressure throttle valve 198 side for atmospheric pressure opening and switches to the path from the second sub-tank side air pressure adjusting pump 174. The air from the second sub-tank 164 on the downstream is thus suctioned out into the atmosphere from the second sub-tank side air pressure adjusting pump 174 through the downstream three-way valve 192, so that the interior of the second sub-tank 164 becomes a negative pressure. When carrying out the positive pressure holding control, the upstream three-way valve (pressurization switching three-way valve) 190 separates the positive pressure throttle valve 198 side for atmospheric pressure opening and switches to the sub-tank 162 side, and the downstream three-way valve (negative pressure switching three-way valve) 192 separates the path from the second sub-tank side air pressure adjusting pump 174 and switches to the positive pressure throttle valve 198 side for atmospheric pressure opening. The air is thus suctioned in from the positive pressure throttle valve 198 and sent to the first sub-tank 162 by the first sub-tank side air pressure adjusting pump 172, thus maintaining the positive pressure in the first sub-tank 162. Furthermore, the second sub-tank 164 takes in the air from the positive pressure throttle valve 198. In other words, the in-path air pressure of the two sub-tanks is collectively controlled with one system.

Through the operations described above, the ink pressure in the inkjet head 160 can be controlled through the air pressure adjustment of the first sub-tank 162 and the second sub-tank 164.

FIG. 8A describes the negative pressure holding control by the controller 30. When the air pressure is higher than a predetermined pressure in the negative pressure sensor 187, the controller 30 separates the downstream three-way valve (negative pressure switching three-way valve) 192 from the positive pressure throttle valve 198 side for atmospheric pressure opening and switches to the path from the second sub-tank side air pressure adjusting pump 174. The rotation number of the second sub-tank side air pressure adjusting pump 174 is then increased, and the air pressure of the second sub-tank 164 is lowered. Since the current state merely needs to be maintained when the negative pressure sensor 187 is in an appropriate negative pressure, the controller 30 maintains the rotation speed of the negative pressure sensor 187 with the downstream three-way valve (negative pressure switching three-way valve) 192 switched to the path from the second sub-tank side air pressure adjusting pump 174. When the air pressure is lower than the predetermined pressure in the negative pressure sensor 187, the controller 30 separates the downstream three-way valve (negative pressure switching three-way valve) 192 from the path from the second sub-tank side air pressure adjusting pump 174 and switches to the positive pressure throttle valve 198 side for atmospheric pressure opening. The second sub-tank side air pressure adjusting pump 174 is then stopped.

FIG. 8B is a graph describing a temporal change in pressure in the two sub-tanks. First, immediately after the start of the operation of the shaping device 1, the air pressure of the first sub-tank 162 as well as the air pressure of the second sub-tank 164 are started from the positive pressure, and the controller 30 carries out the control of the air supplying controller 80. At this time, as previously described, the controller 30 separates the downstream three-way valve (negative pressure switching three-way valve) 192 from the positive pressure throttle valve 198 side for the atmospheric pressure opening and switches to the path from the second sub-tank side air pressure adjusting pump 174, and carries out the operation of the second sub-tank side air pressure adjusting pump 174. The downstream two-way valve 196 is then in an opened state. While the shaping device 1 ejects ink from the inkjet head 160 to carry out shaping (during shaping), the second sub-tank (downstream sub-tank) 164 is at an appropriate pressure, for example, maintained at −4.7 kPa±0.4 kPa, and the first sub-tank (upstream sub-tank) 162 is also at an appropriate pressure, for example, maintained at 0 kPa±0.4 kPa. When once stopping the shaping and restart is expected (during stopping), the second sub-tank (downstream sub-tank) 164 is at an appropriate pressure, for example, maintained at −4.7 kPa±0.4 kPa, and the first sub-tank (upstream sub-tank) 162 is also at an appropriate pressure, for example, maintained at 0 kPa±0.4 kPa.

The inkjet head 160 to be controlled is assumed to be filled with ink.

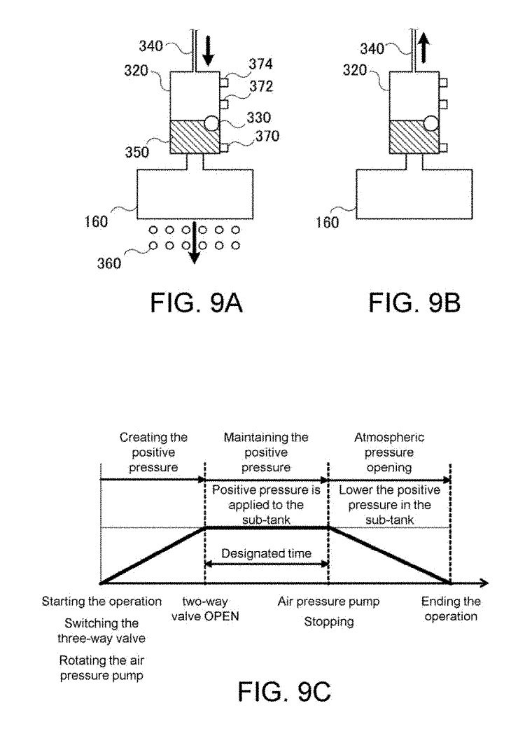

FIG. 9A is an explanatory view of an operation of positive pressure controlling the sub-tank and carrying out purge. A purge control of applying positive pressure from the air path 200 is carried out during the ink filling and cleaning of when pushing the ink in the sub-tank into the inkjet head 160, and during the pushing out of the ink and cleaning fluid in the flow path of the ink, the sub-tank and the inkjet head 160 from the nozzle. Specifically, scenes such as filling the ink to the inkjet head 160, cleaning the inkjet head 160, and replacing the ink are examples.

First, air is sent from the air path 340 to have the interior of the sub-tank 320 to a positive pressure. The ink stored in the sub-tank 320 is then pushed out to the inkjet head 160, and ink 360 is ejected from the nozzle (not shown) of the inkjet head 160.

FIG. 9B is an explanatory view of a state in which the interior of the sub-tank is negative pressure controlled after the purge. After the purge is carried out for a certain period of time, the air is extracted from the air path 340 to have the air pressure in the sub-tank 320 to a negative pressure. This operation prevents ink from dripping from the inkjet head 160.

FIG. 9C is a graph describing an operation of a positive pressure holding control by the air supplying controller 80.

The purge control of applying a positive pressure to the ink is carried out by operating the first sub-tank side air pressure adjusting pump 172, and applying a predetermined pressure, for example, 3 kPa±0.2 kPa for a certain period of time. Specifically, the controller 30 separates the upstream three-way valve (pressurization switching three-way valve) 190 from the positive pressure throttle valve 198 for atmospheric pressure opening and switches to the sub-tank 162 side, and starts the operation of the first sub-tank side air pressure adjusting pump 172. In this case, the upstream two-way valve 194 is in a closed state during the generation of the positive pressure. Next, to apply the positive pressure to the first sub-tank 162 and maintain the same, the upstream two-way valve 194 is opened and the air pressure is maintained for a designated time. After elapse of a designated time, the first sub-tank side air pressure adjusting pump 172 is stopped to lower the pressure in the sub-tank, and the upstream three-way valve (pressurization switching three-way valve) 190 is separated from the sub-tank 162 side and switched to the positive pressure throttle valve 198 side for atmospheric pressure opening to have the back flow preventing filter 166 in the atmospheric opened state.

According to the shaping device 1 of the embodiment of the present disclosure, the inkjet head 160 includes the sub-tank for storing a small amount of ink, and the ink pressure in the sub-tank is controlled, so that a beneficial effect in that the ink pressure in the vicinity of the nozzle 202 and the nozzle 204 can be easily adjusted is obtained.

The air pressure in the sub-tank is made to a negative pressure to prevent extra ink from dripping from the nozzle while the shaping by the predetermined ink is stopped. According to the shaping device 1 of the embodiment of the present disclosure, the air pressure adjusting pump for changing the air pressure in the sub-tank is further provided, where the controller 30 controls the air pressure adjusting pump such as the first sub-tank side air pressure adjusting pump 172 and the second sub-tank side air pressure adjusting pump 174 to adjust the pressure of supplying ink from the sub-tank to the inkjet head 160, and hence a beneficial effect of preventing ink from dripping is obtained by easily making the air pressure in the sub-tank to a negative pressure and the ink pressure in the vicinity of the nozzle to a negative pressure.

In the inkjet head 160, air bubbles are generated in the nozzle by the cavitation effect. The air always exists in the sub-tank and the air is also accumulated at the upper part of the ink container 100, and a surface area of the ink exposed to air is large particularly in a large ink container 100. The ink forms an aggregate having a diameter of a few dozen microns when exposed to oxygen, which becomes a cause of nozzle clogging and lowering in output accuracy. According to the shaping device 1 of the embodiment of the present disclosure, as the deaerating module 154 for carrying out deaeration of the ink is arranged in the ink circulating path 145, the ink is deaerated and the generation of air bubbles by the cavitation effect is suppressed, and the ink is less likely to be aggregated, whereby a beneficial effect in that break down is less likely to occur is obtained.

According to the shaping device 1 of the embodiment of the present disclosure, the sub-tank is arranged at the upstream and the downstream of the nozzle of the inkjet head 160, respectively, so that an effect of being able to easily control the ink pressure in the vicinity of the nozzle 202 and the nozzle 204 is obtained by controlling the air pressure of the respective sub-tank.

The shaping device of the present disclosure is not limited to the embodiment described above, and various modifications may, of course, be made within a scope not deviating from the gist of the disclosure.

For example, in the embodiment described above, the pressure of the first sub-tank 162 and the second sub-tank 164 is controlled by the air pressure adjusting pump of the air supplying controller 80, but a pressure adjustment by a so-called mechanical damper may be carried out.

Furthermore, with respect to the refilling of the ink from the refill container 90 to the ink container 100 by the set value of the weight measuring portion 120, an embodiment in which the controller 30 operates the ink refilling pump 110 to refill the ink when the weight of the ink becomes smaller than the predetermined set value has been described, but this is not the sole case. In other words, for the ink container 100 of the ink of each color, a lower limit set value, which is a lower limit of the set value and a threshold value at which the ink is refilled from the refill container 90 to the ink container 100 when smaller than or equal to the set value, and an upper limit set value, which is an upper limit of the set value and a threshold value at which the refilling of the ink from the refill container 90 to the ink container 100 is stopped when greater than or equal to the set value are respectively provided to control the start of ink refill and stop of ink refill. In this case, for the coloring ink of which the consumption amount is assumed to be small, consideration is made to reduce the different of the lower limit set value and the upper limit set value to increase the refilling frequency and reduce the time the ink is retained in the ink container 100 exposed to air. In this case, the refill container 90 is desirably a container that prevents deterioration by being filled with inactive gas. In addition, the controller 30 may estimate the ink amount to consume from the so-called 3D data of the three-dimensional object, and set the lower limit set value and the upper limit set value for the ink of each color. Furthermore, the controller 30 may estimate the ink amount remaining in the refill container 90 from the refilled ink amount, and issue a warning urging the replacement of the refill container 90 to the user.

For example, in another alternative example, the amount of ink in the ink container 100 may be controlled, for example, by a bobber (float) provided inside the ink container 100 and the liquid level detection device of the ink, rather than being controlled accurately based on the weight of the ink measured by the weight measuring portion 120. Furthermore, a configuration of the ink circulating path similar to the embodiment described above may be adopted irrespective of the method of supplying ink from the ink supplying system 50 to the ink path controller 60 and the carriage 70.

Furthermore, in the embodiment of the present disclosure described above, the weight of the ink stored in the ink container 100 is measured in the weight measuring portion 120, and the need to refill the ink is determined with the set value therefor, but this mode is not the sole case. For example, in an alternative example, the weight combining the ink container storing the ink and the ink may be measured by the weight measuring portion 120, a threshold value, that is, a set value may be determined for the weight combining the ink container storing the ink and the ink, and the controller 30 may control the refilling of the ink from the refill container 90 to the ink container 100.

In other words, the shaping device 1 that shapes a stereoscopic three-dimensional object by discharging ink includes the plurality of inkjet heads 160 that eject inks of colors different from each other; the plurality of ink supplying systems 50 that supply corresponding ink to each of the plurality of inkjet heads 160; and the ink circulating path 145 through which the ink circulates; where in the ink circulating path 145, the first sub-tank 162 and the second sub-tank 164 that are arranged in the vicinity of the inkjet head 160 to store the ink, and that refill the ink to the inkjet head 160 are arranged; the three-way valve 140 that switches an input from two inlets and outputs to one outlet, the first flow path 156 arranged on the outlet side and to which the ink pump 150 for sending the ink to the first sub-tank 162 and the second sub-tank 164 is connected, the supplying path 130 that is arranged on the first inlet side and supplies the ink from the ink container 100, and the second flow path 170 that is arranged on the second inlet side and returns the ink from the first sub-tank 162 and the second sub-tank 164 are arranged; in the first flow path 1156, the deaerating module 154 that deaerates the ink is arranged, in at least one of the first sub-tank 162 or the second sub-tank 164, the liquid level detection sensor that detects the liquid level of the ink in the sub-tank is arranged and the controller 30 that controls the ink supply from the plurality of ink supplying systems 50 to the plurality of inkjet heads 160 is arranged; and the controller 30 switches the input of the three-way valve 140 based on a measurement value of the liquid level detection sensor 210.

What is claimed is:

1. A shaping device that shapes a stereoscopic three-dimensional object by discharging an ink, the shaping device comprising:
a plurality of inkjet heads that eject the ink of a color different from each other;
a plurality of ink supplying systems that supply a corresponding ink to each of the plurality of inkjet heads; and
a controller that controls a supply of the ink from the plurality of ink supplying systems to the plurality of inkjet heads;
wherein each of the ink supplying system comprising:
a weight measuring portion that measures at least a weight of the ink stored in an ink container; and
an ink refilling pump that extracts the ink from a refill container capable of refilling the ink to the ink container and refills the ink to the ink container;
wherein the controller controls the ink refilling pump to refill the ink from the refill container to the ink container, when the weight of the ink measured by the weight measuring portion becomes smaller than or equal to a set value which is predetermined; and
the set value is changeable.

2. The shaping device according to claim 1, wherein the plurality of ink supplying systems at least comprising:
a first ink supplying system that supplies a first ink, and
a second ink supplying system that supplies a second ink different from the first ink;
wherein a first set value set with respect to the first ink supplying system is relatively smaller than a second set value set with respect to the second ink supplying system.

3. The shaping device according to claim 2, wherein
the first set value is greater than or equal to 1/20 of the second set value, and
the first set value is smaller than or equal to ½ of the second set value.

4. The shaping device according to claim 2, wherein
a capacity of the ink container used in the first ink supplying system and a capacity of the ink container used in the second ink supplying system are substantially equal.

5. The shaping device according to claim 2, wherein
the three-dimensional object colored using a plurality of coloring inks different from each other is shapeable;
the first ink is the coloring ink; and
the second ink is a white ink.

6. The shaping device according to claim 2, wherein
the three-dimensional object colored using a plurality of coloring inks different from each other is shapeable;
the first ink is the coloring ink; and
the second ink is an ink to become a material of a support layer that supports the three-dimensional object being shaped.

7. The shaping device according to claim 2, wherein
the three-dimensional object colored using a plurality of coloring inks different from each other is shapeable;
the first ink is the coloring ink; and
the second ink is a clear ink, which is a clear colored ink.

8. The shaping device according to claim 1, further comprising:
an ink circulating path through which the ink circulates;
wherein in the ink circulating path, being arranged with:
a sub-tank that is arranged in a vicinity of the inkjet head to store the ink and that refills the ink to the inkjet head,
a three-way valve that switches an input from a first and a second inlets and outputs to one outlet,
a first flow path arranged on a side of the outlet and connected with an ink pump that sends the ink to the sub-tank,
a supplying path arranged on a side of the first inlet and supplies the ink from the ink container, and
a second flow path arranged on a side of the second inlet and returns the ink from the sub-tank;
wherein in the sub-tank, a liquid level detection sensor that detects a liquid level of the ink in the sub-tank is arranged, and
the controller switches the input of the three-way valve based on a measurement value of the liquid level detection sensor.

9. The shaping device according to claim 8, further comprising:
an air pressure adjusting pump that changes an air pressure in the sub-tank;
wherein the controller controls the air pressure adjusting pump to adjust a pressure of supplying ink from the sub-tank to the inkjet head.

10. The shaping device according to claim 8, wherein
a deaerating module that carries out deaeration of the ink is arranged in the ink circulating path.

11. The shaping device according to claim 7, wherein
in the ink circulating path, a first sub-tank arranged upstream of the inkjet head, and a second sub-tank arranged downstream of the inkjet head are arranged.

12. A shaping device that shapes a stereoscopic three-dimensional object by discharging an ink, the shaping device comprising:
a plurality of inkjet heads that eject the ink of a color different from each other;
a plurality of ink supplying systems that supply a corresponding ink to each of the plurality of inkjet heads; and
an ink circulating path through which the ink circulates;
wherein in the ink circulating path, being arranged with:
a sub-tank that is arranged in a vicinity of the inkjet head to store the ink and that refills the ink to the inkjet head,
a three-way valve that switches an input from a first and a second inlets and outputs to one outlet,
a first flow path arranged on a side of the outlet and connected with an ink pump that sends the ink to the sub-tank,
a supplying path arranged on a side of the first inlet and supplies the ink from the ink container, and
a second flow path arranged on a side of the second inlet and returns the ink from the sub-tank;
wherein a deaerating module that carries out deaeration of the ink is arranged in the ink circulating path;
in the sub-tank, a liquid level detection sensor that detects a liquid level of the ink in the sub-tank, and a controller that controls a supply of the ink from the plurality of ink supplying systems to the plurality of inkjet heads are arranged; and
the controller switches the input of the three-way valve based on a measurement value of the liquid level detection sensor.

13. A shaping method that shapes a stereoscopic three-dimensional object by discharging an ink, wherein with respect to a plurality of inkjet heads that eject the ink of a color different from each other, and a plurality of ink supplying systems that supply a corresponding ink to each of the plurality of inkjet heads; the shaping method comprising:
controlling a supply of the ink from the plurality of ink supplying systems to the plurality of inkjet heads;
measuring at least a weight of the ink stored in an ink container;
extracting the ink from a refill container capable of refilling the ink to the ink container and refilling the ink to the ink container; and
controlling an ink refilling pump to refill the ink from the refill container to the ink container, when the weight of the ink measured by a weight measuring portion becomes smaller than or equal to a set value which is predetermined;
wherein the set value is changeable.

14. The shaping method according to claim 13, wherein
with respect to at least a first ink supplying system that supplies a first ink and a second ink supplying system that supplies a second ink different from the first ink, a first set value set with respect to the first ink supplying system is relatively smaller than a second set value set with respect to the second ink supplying system.
